(19) United States
(12) Patent Application Publication
(10) Pub. No.: US 2006/0259287 A1
(43) Pub. Date: Nov. 16, 2006

(54) Vehicle chassis and power train set up tool for track trajectory and speed optimization

(76) Inventors: Frederic F. Jacquelin, Canton, MI (US); David A. Hall, Novi, MI (US); Charles Paulson, Wichita Falls, TX (US); Russell J. Wakeman, Canton, MI (US); Charles Yuan, Troy, MI (US)

Correspondence Address: BUTZEL LONG;DOCKETING DEPARTMENT, 100 BLOOMFIELD HILLS PARKWAY, SUITE 200, BLOOMFIELD HILLS, MI, 48304, US

(21) Appl. No.: 11/399,902

(22) Filed: Apr. 7, 2006

Related U.S. Application Data
(60) Provisional application No. 60/669,470, filed on Apr. 8, 2005.

(51) Int. Cl. G06G 7/48

(52) U.S. Cl. 703/8

(57) ABSTRACT

A tool that obtains a performance goal based on actual calculated performance of the vehicle, thereby eliminating a driver model. The tool includes an optimizer to determine path target points to be sent to controls, such as a steering controller, to obtain a performance goal—such as minimum transit time for a road segment. The design parameters and target lateral coordinates are input to a closed loop steering controller in a generic vehicle dynamic code. The invention uses discrete points to describe targets for path and speed making the use of optimization tools effective. The optimization is based on the actual calculated performance of the vehicle; therefore the path followed by the vehicle may be different from that described by the target(s). The target path is simply modified to obtain the best performance.

### CROSS-REFERENCE TO RELATED APPLICATION

This application claims the benefit of U.S. provisional patent application Ser. No. 60/669,470 filed Apr. 8, 2005.

### BACKGROUND OF THE INVENTION

1. Field of the Invention

The present invention relates generally to a tool that allows for the optimization of the transit time for a vehicle to cover a track or circuit.

2. Description of the Related Art

In the development of automotive vehicles, computer vehicle models may be used to test various designs of the vehicle chassis and power train under variable conditions to achieve optimum performance. Instead of using pre-defined models to derive optimum performance simulation of a vehicle on a track, as previously done, the tool of the present invention generates target and design parameters as inputs to a plurality of vehicle system controllers and calibration modules to obtain a performance goal.

An advantage over existing technology is that the tool provides an optimizer connected to a steering controller, a braking controller, a throttle controller, an engine calibration module, a powertrain module and a vehicle calibration module that cooperate with the optimizer to generate outputs based upon a performance goal to produce a vehicle system simulation.

A further advantage over existing technology is that the tool provides trajectory optimization independent of a driver model.

The nearest known technology for producing a vehicle system is the quasi-steady states model optimization that incorporates pre-defined paths and maps of “maximum capabilities” of a car. This model integrates around the path to obtain a lap time using manual or driver model based optimization of the trajectory around a track. Shortcomings of this tool include that the assumed path may not be optimal, any modifications to the vehicle or non predictable engine performance upon engine modification prior to or during simulation implies modifications to the optimal path and steady state simulations ignore effects of dampers, road roughness, and dynamic load transfer.

An alternative simulation system provides an intermediate driver model that allows a user to define a path and employs closed loop controls to follow the path. Shortcomings of this driver model are that the user defined path will never be optimal, and may not be realistic. Further the closed loop controls may attempt to but generally do not follow the path precisely.

Another alternative simulation system provides an advanced driver model that uses a reduced-complexity vehicle dynamics model, quasi-steady state maps, and user specified information about driver behavior (“aggressiveness”) to define a path “nearly optimal” and a set of open-loop control inputs. Closed loop controls adjust control inputs to account for differences between actual dynamic performance and estimate, and to allow modifications to the vehicle. A shortcoming of this driver model is that the algorithms contain hard-wired behavioral assumptions, which are never exactly true.

Past attempts at optimization have been made. Difficulties have arisen because optimization tools are effective at finding discrete parameter values, but vehicle control inputs are continuous and must be capable of being smooth. Ordinarily, when optimization is used to develop continuous information, it is described by a curve or polynomial so a few discrete coefficients can be the actual output from the optimization.

### SUMMARY OF THE INVENTION

The apparatus and method of the present invention overcomes these deficiencies by providing a tool that obtains a performance goal based on actual calculated performance of the vehicle, thereby eliminating a driver model.

In a first preferred embodiment the tool of the present invention allows for the optimization of the transit time for a vehicle to cover a track or circuit by optimizing the trajectory target points around the track. The tool includes an optimizer to determine path target points to be sent to controls, such as a steering controller, to obtain a performance goal—such as minimum transit time for a road segment. The design parameters and target lateral coordinates are input to a closed loop steering controller in a generic vehicle dynamic code. The achieved trajectory is only limited by the vehicle chassis and power train physical limitations. The invention uses discrete points to describe targets for path and speed making the use of optimization tools effective. The optimization is based on the actual calculated performance of the vehicle; therefore the path followed by the vehicle may be different from that described by the target(s). The target path is simply modified to obtain the best performance.

### DESCRIPTION OF THE DRAWINGS

The above, as well as other advantages of the present invention will become readily apparent to those skilled in the art from the following detailed description of a preferred embodiment when considered in the light of the accompanying drawings in which:

FIG. 1 is a block diagram of the set up tool in accordance with the present invention.

### DESCRIPTION OF THE PREFERRED EMBODIMENT

U.S. provisional patent application Ser. No. 60/669,470 filed Apr. 8, 2005 is hereby incorporated herein by reference.

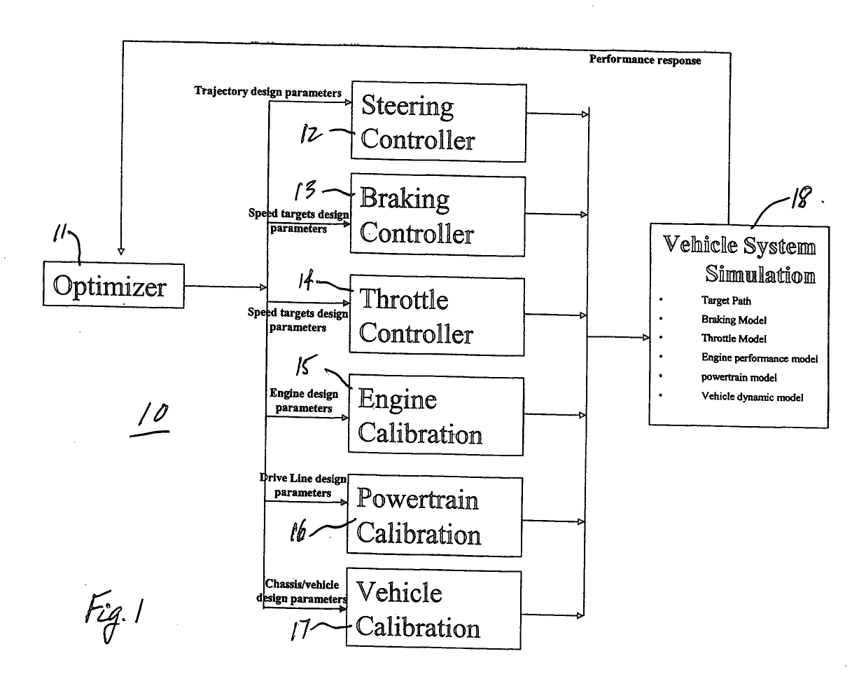

There is shown in FIG. 1 a vehicle chassis and power train set up tool 10 for optimizing track trajectory and speed. The tool 10 generates target and design parameters as inputs to a plurality of vehicle system controllers and calibration modules to obtain a performance goal. The tool includes an optimizer 11 connected to a steering controller 12, a braking controller 13, a throttle controller 14, an engine calibration module 15, a powertrain module 16 and a vehicle calibration module 17. Based upon a performance goal, the controllers and modules 12 through 17 cooperate with the optimizer 11 to generate outputs to produce a vehicle system simulation 18.

For example, the optimizer 11 is connected to the steering controller 12 to enerate trajectory design parameters to the controller 12 to control steering of a vehicle. The optimizer 11 is connected to the braking controller 13 to generate speed targets design parameters to the controller 13 to control braking of the vehicle. The optimizer 11 is connected to the throttle controller 14 to generate speed targets design parameters o the controller 14 to control acceleration of the vehicle. The optimizer 11 is connected to the engine calibration module 15 to generate engine design parameters to the module 15 to define the performance of the engine of the vehicle. The optimizer 11 is connected to the powertrain calibration module 16 to generate drive line design parameters to the module 16 to define the performance of the drive train of the vehicle. The optimizer 11 is connected to the vehicle calibration module 17 to generate chassis/vehicle design parameters to the module 17 to define the performance of the chassis and related components of the vehicle.

Each of the controllers and modules 12 through 17 is connected to a vehicle system simulation 18 which generates a performance response as feedback to the optimizer 11. The vehicle system simulation 18 includes a target path, a braking model, a throttle model, an engine performance model, a powertrain model and a vehicle dynamic model.

The tool 10 allows for the optimization of the transit time for a vehicle to cover a track or circuit by optimizing the trajectory target points around the track. The design parameters and target lateral coordinates are input to the closed loop steering controller 12 in the generic vehicle dynamic code. Therefore, no driver model is needed. The achieved trajectory is only limited by vehicle chassis and power train capabilities. Therefore, the limitations are physics based rather than system based. The use of discrete points to describe targets for path and speed makes the use of the optimization tool effective. The optimizer 11 determines path target points to be sent to the controls to obtain some performance goal such as minimum transit time for a road segment. Since the optimization is based on the actual calculated performance, it doesn't matter that the actual path followed is different from that described by the targets. The target path is simply modified to obtain best performance.

Optimizing the braking and acceleration points along the track is successfully provided by the tool 10. Braking distance and acceleration points are optimized within the braking and acceleration capabilities of the vehicle. The design parameters are input to the throttle and braking controller models 14 and 13 and are linked to the generic vehicle dynamic code power train module 15. Throttle and braking controllers are independent, allowing for braking while the throttle is still open, for example. This extends the capabilities of the speed controller to racing applications.

The tool 10 provides for optimizing the power train and vehicle set up parameters such as engine thermodynamics characteristics and geometry, gear ratio and shift schedule, final drive ratio, aerodynamic, chassis, suspensions and weight distribution. The generic engine performance simulation model is physically based, allowing full resolution of the gas exchange process during the transient simulation. This allows for predicting engine performance resulting from changes in engine geometry and valve train operation. It also allows for newer technology or concept design to be included. The tool capabilities in variable valve actuation; camless, variable cam timing and variable manifold operation during the transient operation extend the range of engine technology that can be used by the tool. The engine model is also Real Time capable. The power train models are easily customizable, allowing for the inclusion of any type of transmission, hybrid technology and control such as engine ignition shut off during gear shift (motorsport), clutch/automatic transmission, etc.

The tool 10 provides for the generic optimizer 11 to link the different controllers and modules 12 through 17 and control the flow of design parameters and responses. The optimization code is capable of covering a large design space and converging in a minimum time.

The output of the tool 10 is the optimum trajectory and speed target achievable over a set of vehicle design parameters in order to minimize the transit time of a vehicle. Optimum path and power train change impacts on the optimization for each section of the track are used for trade off analysis within the optimizer in order to design an optimum vehicle set up for a given track.

An advantage over the existing technology is that the tool provides trajectory optimization independent of a driver model. Instead, the optimum target path of the tool proposed is only limited to vehicle performance not driver model calibration.

Other advantages include the elimination of quasi-steady engine maps that do not give realistic transient behavior.

Still further advantages include a generic engine performance model that is physically based so engine parameters can be optimized on the fly, without outer loop or disruption of the main optimization process. In addition, engine parameters can be varied during the simulation allowing for the full range of engine technology to be investigated.

The optimizer of the present invention allows each code to be linked together and provides a continuous process that does not require user inputs between phases: trajectory and vehicle optimization.

Unlike quasi-steady simulation, engine response to throttle impulse and hence overall vehicle behavior is realistic. The optimum solution is therefore implementable directly on the vehicle without post-processing or modification of the actual simulation output.

The vehicle and engine model is Real Time capable allowing for control and HiL tasks to be performed using the same exact and realistic model as used in the optimizer.

The link between the controllers, power train and engine models, vehicle dynamic code and the optimizer is suited for any type of vehicle application, not just for racing.

Run time is increased by the higher accuracy and resolution of the model, especially by the engine, as compared to quasi-steady states map based models but provides real implement able output.

The tool according to the present invention can be used in, but is not limited to, motorsports, domestic vehicle calibration and control development, and power train optimization of specialized vehicle for a given drive cycle.

In accordance with the provisions of the patent statutes, the present invention has been described in what is considered to represent its preferred embodiment. However, it should be noted that the invention can be practiced otherwise than as specifically illustrated and described without departing from its spirit or scope.

What is claimed is:

1. An apparatus for vehicle track trajectory and speed optimization comprising:
an optimizer for generating target values to vehicle system controllers;
a steering controller connected to said optimizer for receiving trajectory design parameters;
a braking controller connected to said optimizer for receiving speed targets design parameters; and
a throttle controller connected to said optimizer for receiving speed targets design parameters.

2. The apparatus according to claim 1 including an engine calibration module connected to said optimizer for receiving engine design parameters.

3. The apparatus according to claim 1 including a powertrain calibration module connected to said optimizer for receiving drive line design parameters.

4. The apparatus according to claim 1 including a vehicle calibration module connected to said optimizer for receiving chassis/vehicle design parameters.

5. A method of optimizing vehicle track trajectory and speed comprising the steps of:
a. generating parameters to vehicle system controllers and calibration modules from an optimizer;
b. running a vehicle system simulation based upon inputs from the vehicle system controllers and calibration modules; and
c. providing a performance response from the vehicle system simulation to the optimizer.

6. The method according to claim 5 including a step of providing trajectory design parameters and speed targets design parameters to the vehicle system controllers.

7. The method according to claim 5 including a step of providing engine design parameters, drive line parameters and chassis/vehicle design parameters to the modules.

8. A simulation system for simulating an operation of a vehicle to obtain an optimization performance goal comprising:
a vehicle chassis and power train set up tool including a an optimizer connected to at least one vehicle controller for receiving design parameters and at least one vehicle calibration module, wherein said optimizer generates an output in response to said controller and calibration module to produce a vehicle system simulation based on said performance goal.

9. The simulation system according to claim 8 including a steering controller connected to said optimizer for receiving trajectory design parameters.

10. The simulation system according to claim 8 including a braking controller connected to said optimizer for receiving speed targets design parameters.

11. The simulation system according to claim 8 including a throttle controller connected to said optimizer for receiving speed targets design parameters.

12. The simulation system according to claim 8 including an engine calibration module connected to said optimizer for receiving engine design parameters.

13. The simulation system according to claim 8 including a powertrain module connected to said optimizer for receiving drive line design parameters.

14. The simulation system according to claim 8 including a vehicle calibration module connected to said optimizer for receiving chassis/vehicle design parameters.

15. A method of optimizing vehicle track trajectory and speed comprising the steps of:
inputting target and design parameters into a plurality of vehicle system controllers and calibration modules to obtain a performance goal,
connecting an optimizer to said vehicle system controllers and calibration modules, and
generating outputs to produce a vehicle system simulation.

16. The method according to claim 15 including a step of running a vehicle system simulation based upon inputs from the vehicle system controllers and calibration modules.

17. The method according to claim 15 including a step of providing a performance response from the vehicle system simulation to the optimizer.

18. The method according to claim 15 wherein said vehicle system controllers includes at least one of a steering controller, a braking controller, and a throttle controller.

19. The method according to claim 15 wherein said calibration modules includes at least one of a powertrain calibration module, a vehicle calibration module, and an engine calibration module.

20. The method according to claim 18 including the step of independently running said braking controller apart from said throttle controller thereby allowing for braking while the throttle is still open.
